(19) United States
(12) Patent Application Publication
(10) Pub. No.: US 2015/0381377 A1
(43) Pub. Date: Dec. 31, 2015

(54) METHOD AND APPARATUS FOR MANAGING ADDRESSES AND CONNECTIVITY ARRANGEMENTS FOR TRANSPORTING MULTICAST DATA IN A WIRELESS NETWORK

(71) Applicant: QUALCOMM TECHNOLOGIES INTERNATIONAL, LTD., Cambridge (GB)

(72) Inventor: Naveen Kumar KAKANI, Coppell, TX (US)

(21) Appl. No.: 14/316,222

(22) Filed: Jun. 26, 2014

(51) Int. Cl. H04L 12/18; H04L 29/12; H04W 4/06

(52) U.S. Cl. CPC H04L 12/189; H04W 4/06; H04L 61/2069

(57) ABSTRACT

The present invention provides methods and apparatuses for managing multicast addresses and connectivity arrangements for transporting multicast data in a wireless network. According to certain aspects, embodiments of the invention enable allocation of multicast addresses to facilitate reliable multicast/groupcast transmissions by any device in a wireless network, and not just an access point, as well as in wireless networks where there is no support for 802.11aa. According to certain other aspects, embodiments of the invention allow for multicast transmission to sinks in a wireless network that are not reachable to the source device even in presence of an access point that does not support IEEE 802.11aa.

### FIELD OF THE INVENTION

The present invention relates to wireless communications, and more particularly to methods and apparatuses for managing multicast addresses and connectivity arrangements for transporting multicast data in a wireless network.

### BACKGROUND OF THE INVENTION

As WiFi networks become nearly ubiquitous, new applications for WiFi are continually being developed. For example, the original IEEE 802.11 standards did not include any support for multicast or groupcast transmissions in the wireless network (i.e. a basic service set, or BSS), which would be useful for applications such as audio and video distribution. Similarly, new technologies have been emerged such as WiFi Direct.

Recently, however, the IEEE 802.11aa standard included definitions for multicast/groupcast transmissions, including a mechanism where a WiFi access point (AP) can provide reliability by allowing for retransmissions of multicast/groupcast (MG) data. The retransmitted MG data is transmitted with a different multicast/groupcast address than the original transmission. This is to ensure that “legacy devices” (i.e., devices that don't support the newer 802.11aa standards) in the network will not be receiving the retransmitted packets, as legacy devices cannot do duplicate packet detection of MG data. An AP can allocate the retransmission address locally as it can safely assume that it is the only device in the network (i.e. BSS) that is allowed to transmit MG data. However, there is currently no standard or other mechanism to enable the use of reliable MG data transmission by non-AP STAs in the BSS and also by devices in WiFi Direct networks (both group owners and clients).

### SUMMARY OF THE INVENTION

The present invention provides methods and apparatuses for managing multicast addresses and connectivity arrangements for transporting multicast data in a wireless network. According to certain aspects, embodiments of the invention enable allocation of multicast addresses to facilitate reliable multicast/groupcast transmissions by any device in a wireless network, and not just an access point, as well as in wireless networks where there is no support for 802.11aa. According to certain other aspects, embodiments of the invention allow for multicast transmission to sinks in a wireless network that are not reachable to the source device, even when the source device is in a BSS or other environment comprising an access point that does not support IEEE 802.11aa.

According to these and other aspects, a method for managing multicast/groupcast (MG) data communications in a wireless system comprising an access point (AP) device, a source device that is separate from the AP device and one or more sink devices that are separate from both the AP and source devices according to embodiments of the invention includes allocating a multicast address by the source device; and wirelessly transmitting MG data from the source device to the one or more sink devices using the allocated multicast address.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a block diagram of an example multicast arrangement in a BSS according to embodiments of the invention;

FIG. 2 is a diagram illustrating a multicast group setup sequence;

FIG. 3 is a block diagram of another example multicast arrangement in a BSS according to embodiments of the invention;

FIG. 4 is a block diagram of another example multicast arrangement in a BSS according to embodiments of the invention; and

FIG. 5 is a block diagram of another example multicast arrangement in a BSS according to embodiments of the invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

According to certain general aspects, embodiments of the invention provide methods for allocating a multicast address for multicast data transmission by a non-AP source device.

IEEE 802.11aa protocol allocates the Layer 2 (i.e. MAC) address for multicast data transmissions based on IETF RFC 3376, in which the IP address of the multicast stream is used to formulate the MAC address (i.e. add a prefix to the IP address), while the re-transmission address is allocated locally by the AP (i.e. one unique address can be allocated for each stream or one address can be the same for all the streams). However, the present inventors recognize that it may be desirable for devices other than the AP to perform multicast data transmissions, in which case a different scheme for allocating multicast addresses is needed.

Although embodiments of the invention will be described in connection with WiFi networks in compliance with IEEE 802.11 standards, the invention is not limited to this example. For example, the principles of the invention can be extended to other wireless communication systems and devices such as WiFi Direct, Adhoc WiFi (IBSS), etc. Those skilled in the art will appreciate how to implement the invention in these and other systems and devices after being taught by the present examples.

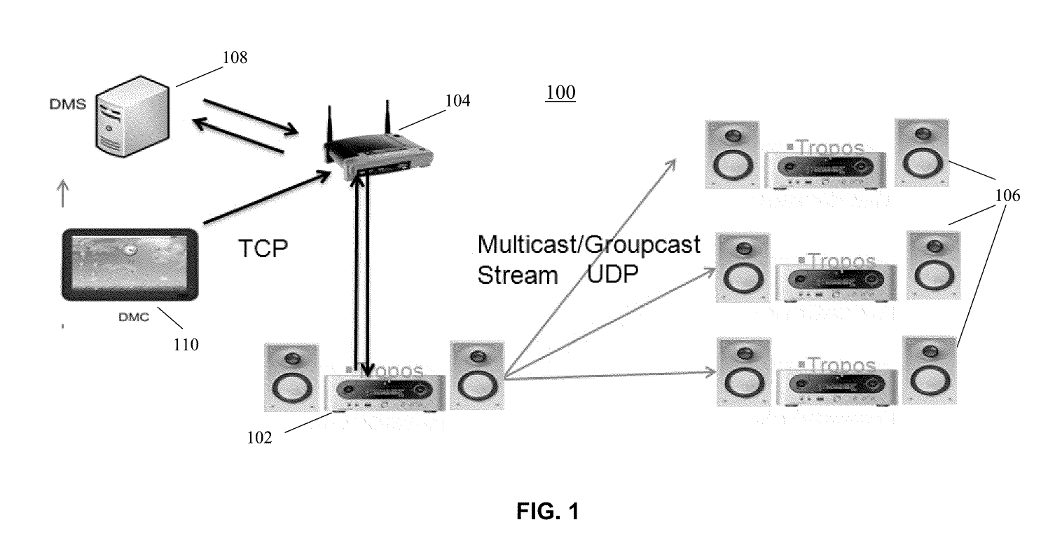

A block diagram of an example alternative WiFi BSS 100 according to embodiments of the invention is shown in FIG. 1. In this example, to implement an IEEE 802.11aa solution, a non-AP source device 102 is the device that is transmitting the multicast data to sink devices 106, rather than AP 104.

Specifically, FIG. 1 shows an example BSS having a WiFi audio system implemented by source device 102 and sink devices 106, as well as DMS 108 and DMC 110. DMS 108 is a source of content (e.g. MPEG video, MP3 audio, etc.) that can be rendered by source device 102 and/or sink devices 106. DMS 108 can be implemented as a WiFi-enabled network storage device, a storage device in a computer having WiFi communication support, or a storage device in a mobile device such as an iPad, iPod, iPhone, etc. DMC 110 is a control device having a user interface with which a user typically interacts to control the selection and playback of content. DMC 110 can be implemented by a remote control tablet device, a mobile device such as an iPad, iPod, iPhone and associated application and operating system software, or a computer and associated application and operating system software (e.g. Windows or Apple OS). The details of a user interface or controls implemented by DMC 110 are not necessary for understanding the present invention, and so such details will be omitted here for the sake of clarity of the invention.

Source device 102 is an audio/video device capable of rendering content (e.g. MPEG video, MP3 audio, etc.) and also having capabilities of acting as a multicast master. As such, source device 102 has built-in WiFi functionality (e.g. a WiFi chipset and associated firmware/software) that preferably supports IEEE 802.11aa, as well as the additional functionalities of the present invention as will be described below. Those skilled in the art will be able to understand how to implement the present invention by adapting IEEE 802.11 functionality of such chipsets and associated firmware/software after being taught by the present examples.

Sink devices 106 are audio/video devices capable of rendering content (e.g. a WiFi speaker that can playback audio from MPEG video, MP3 audio, etc.) and also having capabilities of acting as a multicast slave. As such, sink devices 106 have built-in WiFi functionality (e.g. WiFi chipsets and associated firmware/software) that preferably support IEEE 802.11aa, as well as the additional functionalities of the present invention as will be described below. Those skilled in the art will be able to understand how to implement the present invention by adapting IEEE 802.11 functionality of such chipsets and associated firmware/software after being taught by the present examples.

AP 104 can be implemented by, for example, a wireless access point or router that supports IEEE 802.11aa. However, the invention is not limited to this example and can include any type of wireless station including access points and routers, as well as devices that do not support IEEE 802.11aa.

In a typical operation of the WiFi audio system included in BSS 100, a user selects content for playback using DMC 110, which sends control commands to DMS 108 via AP 104 using TCP/IP over WiFi. In response, DMS 108 sends the selected content to source device 102 via AP 104. Source device 102 then transmits the data via multicast to sink devices 106 using UDP/IP over WiFi and MSDU frames as defined by IEEE 802.11a, and as possibly modified by embodiments of the invention. The selected content is then rendered by sink devices 106.

Because non-AP source device 102 is transmitting multicast data to sink devices 106 in BSS 100 rather than, or in addition to, AP 104, it is required to allocate the Layer 2 multicast address. This is primarily because the content that is transmitted by source device 102 is a multicast IP stream. However, allocating the MAC address for the multicast stream locally by device 102 would require ensuring that the multicast address used is not used elsewhere in the network. This is the same problem that one would face in allocating the retransmission MAC address to realize the 802.11aa protocol. However, in that case, given that an AP based solution is more centralized (i.e. addresses used can be controlled by the administrator of the network via the AP), the probability of an overlap of retransmission MAC address with another device in the network using the same address is minimal.

In the example embodiment of the invention of FIG. 1, therefore, non-AP source device 102 allocates the multicast stream address based on the MAC/IP address of device 102 (typically assigned by the AP 104). If device 102 has multiple streams that it is transmitting, then a further prefix is added to signal a different stream. In one non-limiting example, the MAC address of the stream allocated by device 102 comprises the four MSB's of device 102's MAC address (with group bit=1) plus the 12 LSB's of device 102's MAC address plus the IP address of the device 102.

In situations where device 102 is the device in BSS 100 that is primarily transmitting multicast data, it can use the MAC address of the multicast stream as allocated above for re-transmissions as well. This is for cases where there are no legacy IEEE 802.11 devices in the BSS 100 that are receiving multicast data from device 102. If there are legacy devices in the BSS, the MAC address for the multicast stream can be the same as the MAC address that is allocated as defined in IEEE 802.11aa, but the retransmission MAC address for the multicast stream is allocated as described above.

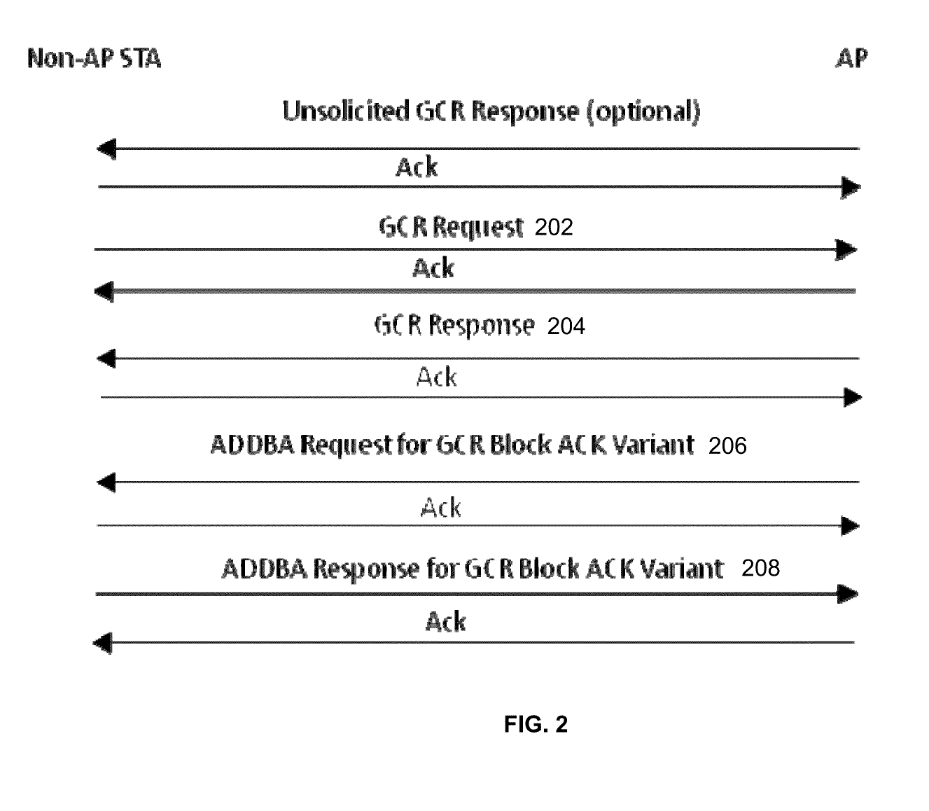

FIG. 2 is a diagram illustrating a GCR setup procedure in accordance with IEEE 802.11aa in a conventional BSS unlike the present invention where the AP is the device transmitting multicast data.

As shown in FIG. 2, possibly after the AP sends an unsolicited GCR response frame, a non-AP STA sends a GCR request frame 202 to the AP. The AP responds to this request frame 202 with a GCR response frame 204. The retransmission of multicast data is done using a multicast address that is allocated by the AP. The retransmission address is also signaled in GCR response frame 204. To further support reliable multicast transmissions, ADDBA request frame 206 and ADDBA response frame 208 can be exchanged as shown in FIG. 2. These frames set up the block acknowledgment (Block ACK) for the GCR service and they also contain the GCR group address element that carries the MAC address of the GCR service.

Embodiments of the invention such as that shown in FIG. 1 alter the standard IEEE 802.11aa GCR setup mechanism shown in FIG. 2 as follows. As described above, the allocated multicast address for the stream can be used not just for regular transmissions of multicast data (as defined in IEEE 802.11aa), but it can also be used for the retransmissions of the multicast data as well. This eases the need for the acknowledgement mechanisms on the sink devices 106 that are receiving the source data by allowing them track a single address instead of two addresses for the same stream. Accordingly, the GCR response frame 204 as shown in FIG. 2 can thus be used to signal that not only the retransmission but also the regular multicast transmissions will use the multicast address.

It should be noted that various acknowledgment mechanisms can also be employed in embodiments of the invention, including those defined by IEEE 802.11aa, as well as those described in co-pending application No. ______ (CONTX13061).

Therefore, according to certain other aspects alluded to above, embodiments of the invention provide connectivity options to transport multicast data that uses the allocated multicast address to allow for retransmission of multicast data.

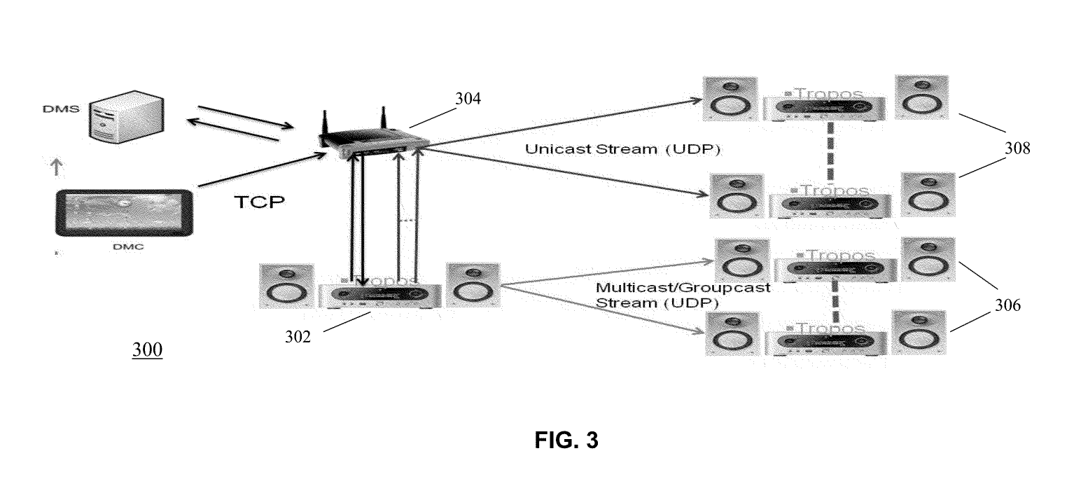

Transporting multicast data using the connectivity embodiment shown in FIG. 1 is a preferable solution, because the source device 102 can control the acknowledgements and the retransmission of lost multicast data. However, in typical scenarios where the media content is to be rendered to devices that are spread out (e.g. home audio distribution), it is not always possible for the source device to be in range to communicate with all the sink devices. According to additional aspects, therefore, for those scenarios, embodiments of the invention such as those shown in FIG. 3 transport content to these devices via an AP.

The example embodiment of BSS 300 in FIG. 3 facilitates transporting data to devices 308 that are not in direct range with the source device 302. These devices 308 are instead reached via AP 304 and the source device 302 transports the content as respective unicast streams specifically destined to each sink device 308. The transport of the multicast stream to devices 306 can be realized as described above in connection with FIG. 1 and the transport of unicast streams to devices 308 via AP 304 can be realized with the available features in IEEE 802.11mc. However, the sink devices 308 that are receiving data via unicast streams might have been receiving data from the source device 302 earlier (or vice versa) as a multicast stream. For example, in a home, the speakers might be fixed, but because of movement of other objects in the home, there might be a blockage between the source device 302 and the sink device. This would require the sink devices to be signaled by the source.

In one example, this signaling could be performed by the sink device signaling to source that it is able to receive the multicast data that is being sent by the source by the received acknowledgments from the sink device. In another example, the signaling could include the source signaling to the sink that it is switching the stream from multicast to unicast or vice versa, along with an associated response back from the sink device. These messages can be defined as part of encapsulated data frames and that would allow the transport of the messages even without the support of the AP.

The connectivity example shown in FIG. 3 allows full reachability to all sink devices. However, the use of unicast transmissions in this example embodiment increases system capacity requirements. Accordingly, additional embodiments of the invention address this scalability issue.

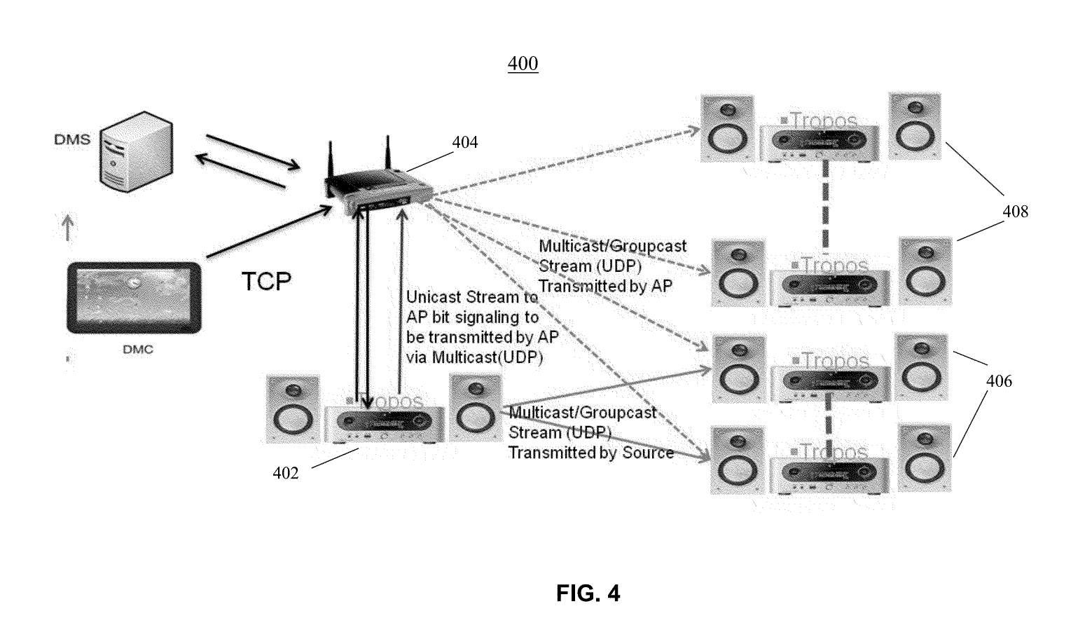

In the connectivity example of BSS 400 shown in FIG. 4, sink devices 408 that are not reachable by source device 402 have data transported to them via AP 404 instead as in the example of FIG. 3, but as a multicast stream. The signaling to have the content received by the AP 404 from the source device 402 to be transported as a multicast stream in the BSS 400 is performed by including the multicast address in the unicast content. This type of signaling is already supported by IEEE 802.11mc.

However, if the AP 404 does not support IEEE 802.11aa, it is not possible to transport the multicast data reliably because there is no support for retransmissions as in IEEE 802.11aa. To facilitate reliability in this scenario, the following method can be used to allow for reliability.

First, a bit map is established at the source device 402 to maintain the reception status of data for sink devices 408 that are receiving multicast data via the AP 404. The source device 402 includes the Sequence Number (Seq. No.) of the data that is transmitted in the data portion that is transmitted to the AP 404. The AP 404 adds its own Seq. No to the data (i.e. the data already includes the Seq. No. from source device 402) that is transmitted to the sinks 408 via a multicast stream. The encoding of the Seq. No. by the source device 402 of the data that is being transmitted to the AP404 can be in an “A-MSDU header” (e.g. the Seq No. for the 802.11 MAC frame is a 12 bits field) or in the actual data itself. Additionally, since the purpose of tracking the sequence number of the packet is to correlate the frame transmitted by the source to the AP, which is then transmitted as a multicast frame by the AP to sink devices, the Seq. No. can be a simple encoding that can fit into the existing MAC header (e.g. a few bits instead of 12 bits for MAC Seq. No.), of an A-MSDU header.

Even though the multicast data is transmitted via AP 404 (with its own Seq. No. allocated by AP 404), it is possible for the source device 402 to track the reception of the packets at the sink devices 408 as follows. The multicast data will be transmitted by the AP 404 typically at beacon time and it will allocate its own Seq. No. for the data that it transmits. The multicast data transmitted by the AP 404 is also received by the source device 402 as the multicast address used by the AP404 to transmit the data is known to the source device. Upon receiving the multicast data transmitted by the AP 404, the source device 402 can correlate the original Seq. No. of the same data (e.g. encoding in MAC header, or A-MSDU header or limiting number of packets transmitted from source to AP to no more than one frame at a time) that it transmitted to the AP 404 to the Seq. No. used by the AP 404 to transmit the same data.

The source device 402 transmits a unicast message to each sink device 408 that is receiving multicast data from the AP 404 with the following information: (1) the original Seq. No. of the data as transmitted by the source device 402; (2) the Seq. No. of the same data that is transmitted by the AP 404; and (3) a request for acknowledgement.

The sinks 408 receive the unicast message from the source device 402 (via AP 404) and transmit a response that includes a bit map of the data as follows: (1) the starting Seq. No. (from the source device 402); and (2) a bit map signaling the reception of each MSDU after the Seq. No. Because the sinks 408 that are receiving the data from the AP 404 know the original Seq. No. from the source of the data that they are receiving from the AP 404, they can do duplicate detection. In this case, the overhead is N_sink*acknowledgement.

The amount of overheads (i.e. additional signaling and medium time required to allow for data reception by sink devices from the AP) in this example are as follows. The size of the frame=MAC Headers+Number of Data Frames*(12 bits original Seq. No.+12 bits Seq. No. of the same data transmitted by the AP 404)=MAC Headers+3 bytes*N (where N is the number of multicast data frames transmitted by the AP 404 after which an acknowledgement is requested). The number of channel accesses=2 (Source device 402 to AP 404 and then AP 404 to sink devices 408). Therefore, if the number of sinks 408 receiving content from AP 404 is N_sink then the total amount of overheads=N_sink*2*(MAC Header+3 bytes*N+channel accesses).

Note that in the connectivity example shown in FIG. 4, the sinks 406 that are receiving content from the source device 402 via multicast can also receive the same content via AP 404. But they can discard the received packets or discard the reception of the data from the AP 404.

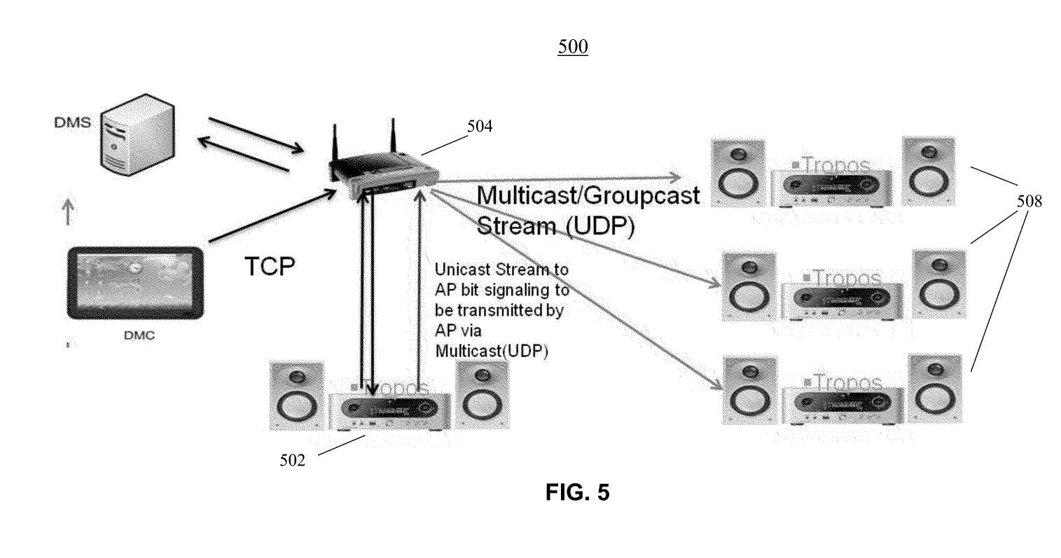

An alternative to the above connectivity example is shown in FIG. 5, in which all the sinks 508 receive content from the AP 504, and none from source device 502. The amount of overheads in this example is N_receivers*2*(MAC Header+3 bytes*N+channel accesses+acknowledgement). This represents an increase in overheads by a factor of N_receivers/N_sink over the example shown in FIG. 4. However, because all the sinks 508 are getting the content via AP 504, the source device 502 is not required to do multicast to the sinks 508 whom it is able to reach directly.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A method for managing multicast/groupcast (MG) data communications in a wireless system comprising an access point (AP) device, a source device that is separate from the AP device and one or more sink devices that are separate from both the AP and source devices, the method comprising:
allocating a multicast address by the source device; and
wirelessly transmitting MG data from the source device to the one or more sink devices using the allocated multicast address.

2. A method according to claim 1, further comprising managing acknowledgements corresponding to the transmitted multicast data from the one or more sink devices at the source device.

3. A method according to claim 2, further comprising performing retransmissions of the transmitted MG data by the source device based on the managed acknowledgments.

4. A method according to claim 3, wherein the retransmissions use the allocated multicast address.

5. A method according to claim 1, wherein transmitting the MG data comprises relaying the MG data between the source device to certain of the one or more sink devices via the AP device.

6. A method according to claim 5, wherein relaying comprises relaying a unicast stream specifically destined to one of the certain sink devices from the source device to the specific one of the certain sink devices via the AP device.

7. A method according to claim 6, wherein transmitting the MG data includes transmitting a MG stream from the source device to the one or more sink devices other than the certain sink devices.

8. A method according to claim 6, wherein relaying the unicast stream is performed using features in IEEE 802.11mc.

9. A method according to claim 6, further comprising requesting acknowledgment from the specific one of the certain devices via the unicast stream.

10. A method according to claim 9, further comprising relaying the requested acknowledgment from the specific one of the certain devices to the source device via the AP.

11. A method according to claim 5, wherein relaying includes sending the MG data from the source device to the AP device in a unicast stream and sending the MG data received by the AP device in the unicast stream to the certain sink devices using a MG stream.

12. A method according to claim 11, wherein signaling to have the MG data received by the AP from the source device relayed to certain sink devices is performed by including the allocated multicast address in contents of the unicast stream.

13. A method according to claim 11, wherein sink devices that receive the same MG data from both the AP and the source device discard packets received from the AP corresponding to the MG data.

14. A method according to claim 11, wherein the AP device supports retransmissions as in IEEE 802.11aa.

15. A method according to claim 11, wherein the AP device does not support retransmissions of the MG stream, the method further comprising managing acknowledgments and retransmissions of the MG stream at the source device.

16. A wireless system comprising:
an access point (AP) device;
a source device that is separate from the AP device; and
one or more sink devices that are separate from both the AP and source devices,
wherein the source device is configured to implement a method for managing multicast/groupcast (MG) data communications in the wireless system, comprising:
allocating a multicast address by the source device; and
wirelessly transmitting MG data from the source device to the one or more sink devices using the allocated multicast address.

17. A wireless system according to claim 16, wherein the method further comprises managing acknowledgements corresponding to the transmitted multicast data from the one or more sink devices at the source device.

18. A wireless system according to claim 17, wherein the method further comprises performing retransmissions of the transmitted MG data by the source device based on the managed acknowledgments.

19. A wireless system according to claim 18, wherein the retransmissions use the allocated multicast address.

20. A wireless system according to claim 16, wherein transmitting the MG data comprises relaying the MG data between the source device to certain of the one or more sink devices via the AP device.
